(19) United States
(12) Patent Application Publication
(10) Pub. No.: US 2003/0035445 A1
(43) Pub. Date: Feb. 20, 2003

(54) Integrated ethernet and PDH/SDH/SONET communication system

(76) Inventor: Tat Yin Choi, San Jose, CA (US)

Correspondence Address: TAT YIN CHOI, 14281 PAUL AVE, SARATOGA, CA, 95070, US

(21) Appl. No.: 09/933,219

(22) Filed: Aug. 20, 2001

(51) Int. Cl. H04J 3/04; H04J 3/02

(52) U.S. Cl. 370/535; 370/539

(57) ABSTRACT

An integrated communication system for communicating Ethernet and PDH/SDH/SONET data using time division multiplexing techniques is provided. The integrated communication system time division multiplexes PDH/SDH/SONET data with Ethernet data, and transmits and receives the combined data stream using Ethernet-based communication technology. The integrated communication system is cost effective for providing both Ethernet and PDH/SDH/SONET communication services, since separate transmission facilities are not required. In addition, the time division multiplexing method is more cost effective than the wave division multiplexing (WDM) method since WDM equipment is not required. The integrated communication system can act as a standalone system or be incorporated into other network systems.

### CROSS-REFERENCE TO RELATED APPLICATION

Not Applicable

### BACKGROUND OF THE INVENTION

The present invention is related to communication systems, specifically to a new method for communicating Ethernet and PDH/SDH/SONET data.

The wide area network (WAN) communication technologies in widespread use today are the plesiochronous digital hierarchy (PDH) and synchronous digital hierarchy (SDH)/synchronous optical network (SONET) systems. In North America, PDH refers to the T-carrier systems with transmission speeds ranging from DS0 (64 kbps) to T3 (44.736 Mbps) and above. In Europe and other parts of the world, the E-carrier system is used with transmission speeds ranging from E0 (64 kbps) to E3 (34.368 Mbps) and above. Japan uses a hierarchy with transmission speeds ranging from J0 (64 kbps) to J3 (32.064 Mbps) and above. For transmission speeds higher than T3/E3/J3, SDH/SONET systems are usually used. In North America, SONET systems with transmission speeds ranging from STS-3 (155.52 Mbps) to STS-N (N*51.84 Mbps) are widely used. In other parts of the world, SDH systems with transmission speeds ranging from STM-1 (155.52 Mbps) to STM-N (N*155.52 Mbps) are used.

Recently, the use of Ethernet communication technology in the WAN has been introduced. These so called Ethernet service providers offer data transmission speeds ranging from 10 Mbps to 1 Gbps using Ethernet communication technology, often at a considerably lower cost per bit than the traditional PDH/SDH/SONET service providers. However, many existing network services depend on PDH/SDH/SONET systems. Currently, for service providers to offer both Ethernet and PDH/SDH/SONET communication services, the Ethernet and PDH/SDH/SONET signals can be put onto separate transmission facilities. Alternately, the Ethernet and PDH/SDH/SONET signals can be put onto the same optical fiber using wave division multiplexing (WDM) techniques. The first method requires separate transmission facilities, while the second method requires WDM equipment. In addition, both methods require separate transmitters and receivers, which raise the cost of providing services to the customer. To reduce the cost of providing PDH/SDH/SONET and Ethernet services, a new communication method is required.

### BRIEF SUMMARY OF THE INVENTION

The present invention provides a cost effective way for communicating both Ethernet and PDH/SDH/SONET data using time division multiplexing techniques. The integrated Ethernet and PDH/SDH/SONET communication system time division multiplexes PDH/SDH/SONET data with Ethernet data and transmits and receives the combined data stream using Ethernet-based communication technology. An exemplary embodiment of the integrated communication system comprises a PDH/SDH/SONET input/output unit, an Ethernet input/output unit, a multiplexer/demultiplexer, encoder(s)/decoder(s), a serializer/deserializer, and optical transmitter and receiver. The PDH/SDH/SONET input/output unit is used to input and output PDH/SDH/SONET data. The Ethernet input/output unit is used to input and output Ethernet data. The multiplexer combines the Ethernet and PDH/SDH/SONET data into a single data stream, and the demultiplexer separates the combined data stream into Ethernet and PDH/SDH/SONET data. The encoder(s)/decoder(s) encodes and decodes the Ethernet and PDH/SDH/SONET data for communication. The serializer/deserializer converts the parallel data into serial data and vice versa. The optical transmitter converts the electrical signal into optical signal, and the optical receiver converts the optical signal into electrical signal.

Four different exemplary embodiments of the integrated Ethernet and PDH/SDH/SONET communication system are provided. They differ in whether an Ethernet media access controller or Ethernet transceiver is used as the Ethernet input/output unit, and whether the same or separate encoder(s)/decoder(s) are used for Ethernet and PDH/SDH/SONET data. In the first exemplary embodiment, an Ethernet media access controller is used as the Ethernet input/output unit, and a PDH/SDH/SONET line interface unit is used as the PDH/SDH/SONET input/output unit. The same encoder/decoder is used for Ethernet and PDH/SDH/SONET data. The Ethernet and PDH/SDH/SONET data are multiplexed before encoding, and demultiplexed after decoding. The second exemplary embodiment is similar to the first except that separate encoders/decoders are used for the Ethernet and PDH/SDH/SONET data. The Ethernet and PDH/SDH/SONET data are encoded prior to multiplexing and decoded after demultiplexing. In the third exemplary embodiment, an Ethernet transceiver is used to input and output Ethernet data instead of a media access controller. The same encoder/decoder is used for Ethernet and PDH/SDH/SONET data. The Ethernet and PDH/SDH/SONET data are multiplexed before encoding, and demultiplexed after decoding. The fourth exemplary embodiment is similar to the third except that separate encoders/decoders are used for the Ethernet and PDH/SDH/SONET data. The Ethernet and PDH/SDH/SONET data are encoded prior to multiplexing, and decoded after demultiplexing.

The integrated Ethernet and PDH/SDH/SONET communication system can act as a standalone system or be incorporated into other network systems. The cases described in the Detail Description of the Invention are exemplary in that the invention is intended to include any number of alternative incorporation of the integrated communication system into other network systems.

### BRIEF DESCRIPTION OF DRAWINGS

The foregoing Summary of the Invention, as well as the following Detailed Description of the Invention, are better understood when read in conjunction with the accompanying drawings, which are included by way of example, and not by way of limitation with regard to the claimed invention.

FIG. 1 shows the first exemplary embodiment of the integrated Ethernet and PDH/SDH/SONET communication system according to aspects of the present invention.

FIG. 2 shows a second exemplary embodiment of the integrated Ethernet and PDH/SDH/SONET communication system. It differs from the first embodiment in that separate encoders/decoders are used for the Ethernet and PDH/SDH/SONET data. The Ethernet and PDH/SDH/SONET data are encoded prior to multiplexing, and decoded after demultiplexing.

FIG. 3 shows a third exemplary embodiment of the integrated Ethernet and PDH/SDH/SONET communication system. It differs from the first embodiment in that an Ethernet transceiver is used to replace the Ethernet media access controller.

FIG. 4 shows a fourth exemplary embodiment of the integrated Ethernet and PDH/SDH/SONET communication system. It differs from the third embodiment in that separate encoders/decoders are used for the Ethernet and PDH/SDH/SONET data. The Ethernet and PDH/SDH/SONET data are encoded prior to multiplexing, and decoded after demultiplexing.

FIG. 5 shows an Ethernet switch which incorporates the integrated Ethernet and PDH/SDH/SONET communication system shown in FIG. 1 or FIG. 2.

FIG. 6 shows the integrated Ethernet and PDH/SDH/SONET communication system shown in FIG. 3 or FIG. 4 acting as a standalone system.

### DETAILED DESCRIPTION OF THE INVENTION

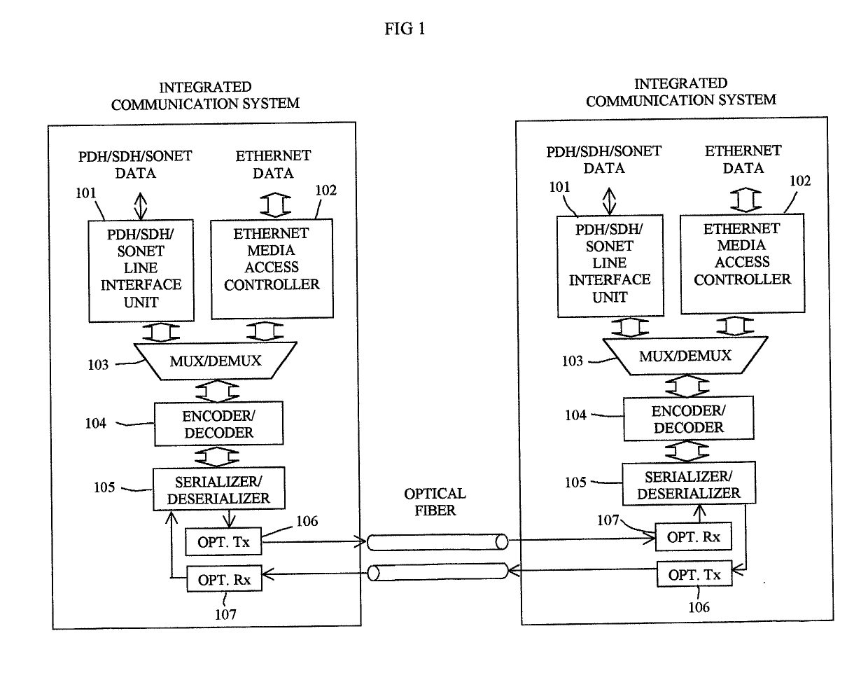

FIG. 1 shows an exemplary embodiment of the integrated communication system which time division multiplexes PDH/SDH/SONET data with Ethernet data, and transmits and receives the combined data stream using Ethernet-based communication technology. The PDH data include the T-carrier system with speeds ranging from DS0 (64 kbps) to DS3 (44.736 Mbps) and above, the E-carrier system with speeds ranging from E0 (64 kbps) to E3 (34.368 Mbps) and above, and the Japanese digital hierarchy with speeds ranging from J0 (64 kbps) to J3 (32.064 Mbps) and above. The SDH data ranges from STM-1 (155.52 Mbps) to STM-N (N*155.52 Mbps). The SONET data ranges from STS-1 (51.84 Mbps) to STS-N (N*51.84 Mbps). The Ethernet data can be any speed ranging from 10 Mbps Ethernet to 10 Gbps Ethernet and higher.

The integrated communication system consists of a PDH/SDH/SONET input/output unit such as a line interface unit (101), an Ethernet input/output unit such as a media access controller (102), a multiplexer/demultiplexer (103), an encoder/decoder (104), a serializer/deserializer (105), and optical transmitter (106) and receiver (107). The PDH/SDH/SONET line interface unit is used for input and output of PDH/SDH/SONET data. In the receive direction, the PDH/SDH/SONET line interface unit (101) performs equalization, clock recovery and other signal processing functions. The line interface unit decodes the PDH/SDH/SONET data into the appropriate serial format. For T-carrier systems, the line interface unit incorporates a B8ZS or appropriate decoder for DS1 signal, and B3ZS or appropriate decoder for DS3 signal. For E-carrier systems, the line interface unit incorporates a HDB3 or appropriate decoder for E1 to E3 signals. The serial data is converted into parallel data and delivered to the multiplexer (103). On the Ethernet side, the media access controller (102) receives packet data from external packet memory, encapsulates the packets into Ethernet frames, performs error processing, and delivers the Ethernet data to the multiplexer (103). Within the multiplexer unit (103), the PDH/SDH/SONET data and the Ethernet data are time division multiplexed and send to the encoder (104) for encoding. The encoded data is then send to the serializer (105) for serialization, and the serialized data is used to drive the optical transmitter (106). The optical transmitter (106) converts the electrical signal to optical signal and sends the optical signal down the fiber.

On the receive side, the optical receiver (107) converts the optical signal into electrical signal and sends the received data to the deserializer (105). The deserializer (105) converts the serial data into parallel data and sends it to the decoder (104) for decoding. The decoded data is separated into PDH/SDH/SONET data and Ethernet data by the demultiplexer (103). The PDH/SDH/SONET data is sent to the line interface unit (101). The line interface unit (101) converts the parallel data into serial data, encodes the serial data into the appropriate format, and performs the signal processing functions required for transmission over the appropriate physical media. For T-carrier systems, the line interface unit (101) encodes the serial data into B8ZS or appropriate format for DS1 signal and B3ZS or appropriate format for DS3 signal. For E-carrier systems, the line interface unit (101) encodes the serial data into HDB3 or appropriate format for E1 to E3 signals. The Ethernet data is send to the media access controller (102). The Ethernet media access controller (102) assembles the data into Ethernet frames, performs error processing, decapsulates the frames into packets, and sends the packet to external packet memory.

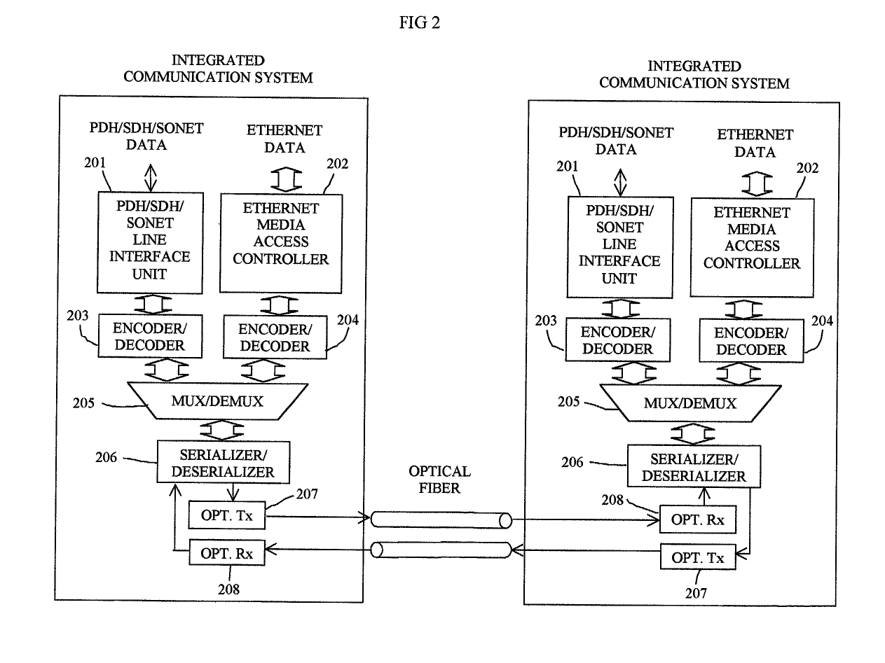

FIG. 2 shows a second exemplary embodiment of the integrated Ethernet and PDH/SDH/SONET communication system. The differences between the first and second exemplary embodiments are that in the second embodiment, separate encoders/decoders (203, 204) are used for PDH/SDH/SONET and Ethernet data, whereas in the first embodiment, the same encoder/decoder (104) is used for both the PDH/SDH/SONET and Ethernet data. The use of separate encoder/decoders (203, 204) allows for the use of different encoding/decoding algorithms for PDH/SDH/SONET and Ethernet data. In addition, in the second embodiment, the multiplexing of PDH/SDH/SONET and Ethernet data by the multiplexer (205) is done after the data has been encoded by the encoders (203, 204), rather than before encoding as is the case in the first embodiment. Similarly, the demultiplexing of PDH/SDH/SONET and Ethernet data by the demultiplexer (205) is done prior to decoding by the decoders (203, 204), rather than after decoding as is the case in the first embodiment. Other than these differences, the first and second exemplary embodiments are similar.

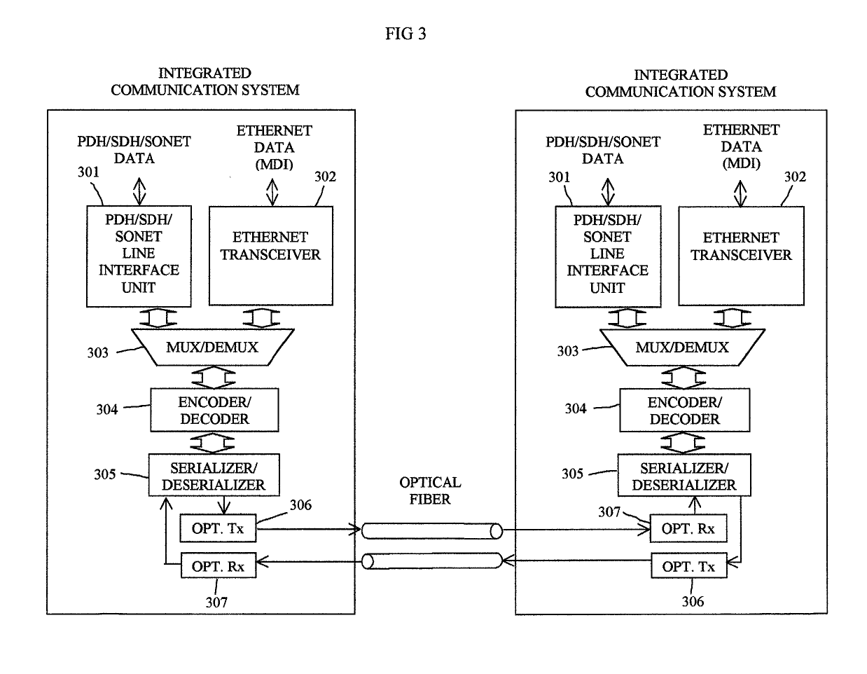

FIG. 3 shows a third exemplary embodiment of the integrated Ethernet and PDH/SDH/SONET communication system. The difference between the first and third exemplary embodiments is that in the third embodiment, an Ethernet transceiver (302) is used to replace the Ethernet media access controller (102) as the Ethernet input/output unit. The Ethernet transceiver (302) converts the serial data at the Media Dependent Interface (MDI) to parallel data at the multiplexer/demultiplexer (303) interface, and vice-versa. The Media Dependent Interface includes both copper and fiber interfaces for 10M to 10G Ethernet and higher. The Ethernet transceiver (302) performs the encoding/decoding, scrambling/descrambling, and signal processing functions required to input and output Ethernet data from the Media Dependent Interface (MDI). At the multiplexer (303), the Ethernet data is multiplexed with the PDH/SDH/SONET data and send to the encoder (304). The encoded data is then send to the serializer (305) for serialization, and the serialized data is used to drive the optical transmitter (306). Conversely, the optical receiver (307) converts the optical signal into electrical signal and sends the serial data to the deserializer (305). The deserializer (305) converts the serial data into parallel data and sends it to the decoder (304) for decoding. The decoded data is demultiplexed into Ethernet and PDH/SDH/SONET data by the demultiplexer (303). The Ethernet data is sent to the Ethernet transceiver (302), and the PDH/SDH/SONET data is sent to the line interface unit (301). Except for the difference mentioned above, the first and third embodiments are similar.

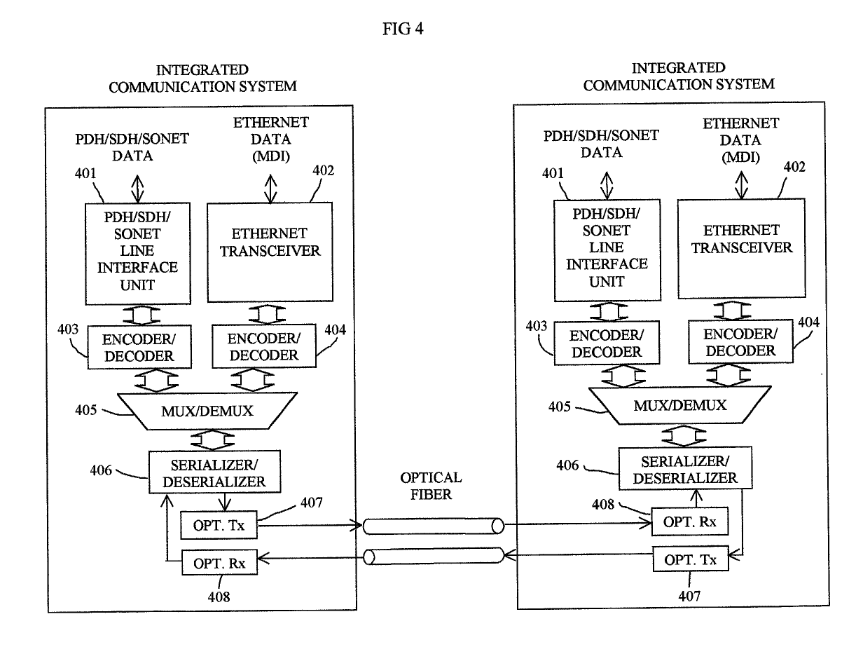

FIG. 4 shows a fourth exemplary embodiment of the integrated Ethernet and PDH/SDH/SONET communication system. The differences between the third and fourth embodiments are that in the fourth embodiment, separate encoders/decoders (403, 404) are used for the PDH/SDH/SONET and Ethernet data, whereas in the third embodiment, the same encoder/decoder (304) is used for both the PDH/SDH/SONET and Ethernet data. The use of separate encoders/decoders (403, 404) allows for the use of different encoding/decoding algorithms for PDH/SDH/SONET and Ethernet data. In addition, in the fourth embodiment, the multiplexing of PDH/SDH/SONET and Ethernet data by the multiplexer (405) is done after the data have been encoded by the encoders (403, 404), rather than before encoding as is the case in the third embodiment. Similarly, the demultiplexing of PDH/SDH/SONET and Ethernet data by the demultiplexer (405) is done prior to decoding by the decoders (403, 404), rather than after decoding as is the case in the third embodiment. Other than these differences, the third and fourth embodiments are similar.

Several methods can be used in the integrated communication system to distinguish between PDH/SDH/SONET and Ethernet data. One method is to add different framing bit or bits to the PDH/SDH/SONET and Ethernet data prior to multiplexing, and to remove the framing bit or bits from the data after demultiplexing. Another method is to insert one or more special characters between the PDH/SDH/SONET and Ethernet data during multiplexing, and remove the special character(s) during demultiplexing. A third method is for the encoder(s) to map the PDH/SDH/SONET and Ethernet data into separate code spaces, that is, different combinations of ones and zeros.

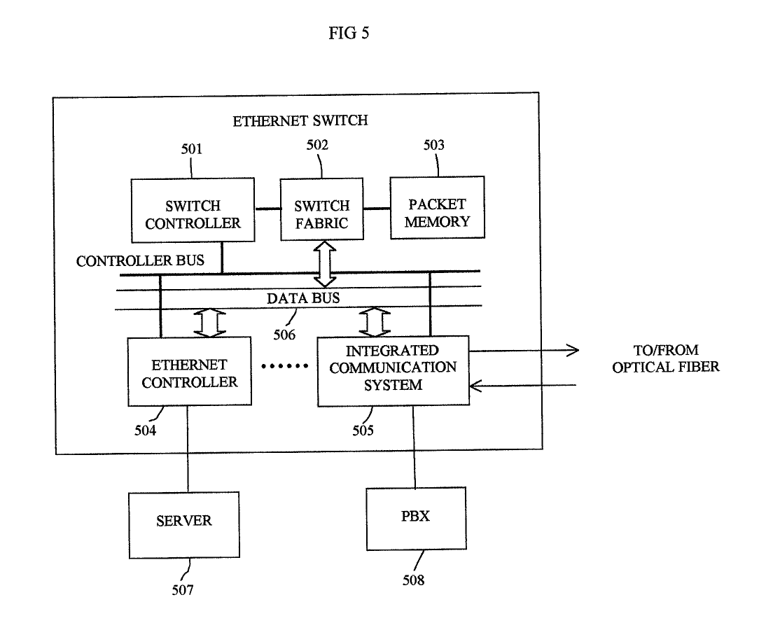

The integrated Ethernet and PDH/SDH/SONET communication systems shown in FIGS. 1-2 can be incorporated into other network systems in various ways. FIG. 5 shows an exemplary incorporation of the integrated communication system into an Ethernet switch. The Ethernet switch consists of a switch controller (501), switch fabric (502), packet memory (503), one or more Ethernet controllers (504), and one or more integrated communication systems (505). The Ethernet media access controller (102, 202) of the integrated communication system interfaces with the data bus (506) of the Ethernet switch. Packet data from data terminal equipment such as a server (507) with an Ethernet interface can be transferred to and from the integrated communication system (505) through the data bus (506). PDH/SDH/SONET terminal equipment such as a PBX (508) is directly connected to the line interface unit (101, 201) of the integrated communication system. The PDH/SDH/SONET data and Ethernet data are multiplexed within the integrated communication system and send to the optical fiber. Similarly, the combined PDH/SDH/SONET and Ethernet data stream received from the optical fiber are demultiplexed within the integrated communication system and send to the PBX (508) and server (507) respectively.

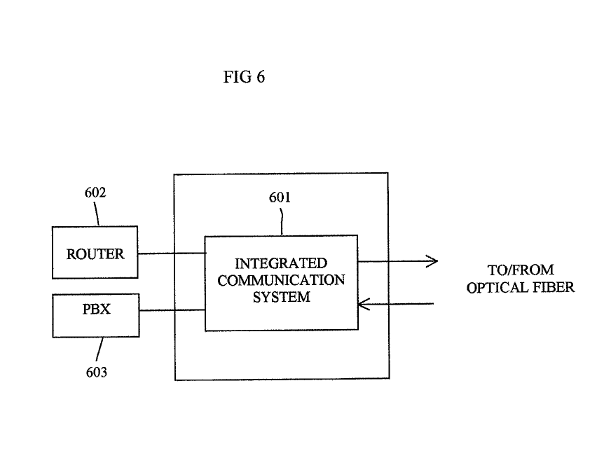

The integrated Ethernet and PDH/SDH/SONET communication systems shown in FIGS. 3-4 can act as a standalone system or be incorporated into other network systems. FIG. 6 shows the integrated communication system (601) acting as a standalone system. For the standalone system, data terminal equipment such as a router (602) with an Ethernet interface can be directly connected to the Ethernet transceiver (302, 402) in the integrated communication system. PDH/SDH/SONET terminal equipment such as a PBX (603) is directly connected to the line interface unit (301, 401) in the integrated communication system. The PDH/SDH/SONET data and Ethernet data are multiplexed within the integrated communication system and send to the optical fiber. Similarly, the combined PDH/SDH/SONET and Ethernet data stream received from the optical fiber is demultiplexed within the integrated communication system and send to the PBX (603) and router (602) respectively.

I claim:

1. A communication system for use in a communication network comprising
A PDH/SDH/SONET input/output unit which inputs and outputs PDH/SDH/SONET data
An Ethernet input/output unit which inputs and outputs Ethernet data
A multiplexer/demultiplexer which time division multiplexes and demultiplexes the PDH/SDH/SONET and Ethernet data
A transceiver unit for processing, and sending and receiving the multiplexed PDH/SDH/SONET and Ethernet data

2. The communication system of claim 1 wherein a line interface unit is used as the PDH/SDH/SONET input/output unit for input and output of PDH/SDH/SONET data.

3. The communication system of claim 1 wherein an Ethernet media access controller or Ethernet transceiver is used as the Ethernet input/output unit for input and output of Ethernet data.

4. The communication system of claim 1 wherein the PDH/SDH/SONET and Ethernet data are time division multiplexed prior to encoding, and demultiplexed after decoding.

5. The communication system of claim 1 wherein the PDH/SDH/SONET and Ethernet data are encoded prior to time division multiplexing, and demultiplexed prior to decoding.

6. The communication system of claim 1 wherein the same or separate encoder(s)/decoder(s) are used to encode and decode PDH/SDH/SONET and Ethernet data.

7. The communication system of claim 1 wherein a serializer/deserializer is used to serialize and deserialize the multiplexed PDH/SDH/SONET and Ethernet data.

8. The communication system of claim 1 wherein a transceiver is used to send and receive the multiplexed PDH/SDH/SONET and Ethernet data.

9. A method for distinguishing between PDH/SDH/SONET and Ethernet data in a communication system comprising adding different framing bit or bits to the PDH/SDH/SONET and Ethernet data prior to multiplexing, and removing the framing bit or bits after demultiplexing.

10. A method for distinguishing between the PDH/SDH/SONET and Ethernet data in a communication system comprising inserting one or more special character(s) between the PDH/SDH/SONET and Ethernet data during multiplexing, and removing the special character(s) during demultiplexing.

11. A method for distinguishing between PDH/SDH/SONET and Ethernet data in a communication system comprising encoding the PDH/SDH/SONET and Ethernet data into separate code spaces, that is, different combinations of ones and zeros.

12. The communication system of claim 1 acting as a standalone system or being incorporated into other network systems.
